(19) United States
(12) Patent Application Publication
(10) Pub. No.: US 2007/0003902 A1
(43) Pub. Date: Jan. 4, 2007

(54) Auxiliary apparatus for dental treatments

(76) Inventor: Franco Castellini, Bologna (IT)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/454,512

(22) Filed: Jun. 16, 2006

(30) Foreign Application Priority Data
Jun. 30, 2005 (IT) B02005A 000439

(51) Int. Cl. A61C 1/02

(52) U.S. Cl. 433/98

(57) ABSTRACT

An auxiliary apparatus (1) for dental treatments comprises at least: a main body (2) constituting a power unit that drives handpieces (5) used for traditional conservative, implant and/or endodontic operations and in turn connected to the unit (2) through a connecting tube (3); handpiece (5) activation and adjustment means (4) located on a surface (2a) of the main body (2) and controlled by a microprocessor unit (6) for controlling the main and auxiliary functions of the handpiece (5) applied to the unit (2); a data display screen (7) mounted on the main body (2); an interface unit (8) connected, on one side, to the microprocessor (6) and, on the other, to the screen (7) and designed to receive from the microprocessor (6) at least one signal (S) corresponding to a data item (D) that is a function of the torque value (V5) of the handpieces (5) being used and to convert it into at least one graphic viewing field (CV) on the screen (7) in real time so as display the graph (TR) of torque over time (t) corresponding to the use of the connected handpiece (5). [FIG. 1]

### BACKGROUND OF THE INVENTION

This invention relates to an auxiliary apparatus for dental treatments where the operating parameters of the handpieces applied can be displayed.

It is well known that dental surgeries use auxiliary apparatus (also referred to as “stand-alone” apparatus because it is separate from the traditional dental unit) to administer dental treatment on patients using specific handpieces that may supplement or be used instead of the handpieces and equipment located on the dental unit.

These specific treatments, for example involving endodontic or implant operations (besides dental hygiene and/or whitening treatments) are performed using the auxiliary apparatus, which essentially comprises:

a main body constituting the power unit that drives the handpieces in turn connected to the unit through a tube;

means for activating the handpiece and adjusting its operating parameters, these means being located on a surface of the main body and being controlled by

a microprocessor unit for controlling the main and auxiliary functions of the handpiece applied to the apparatus.

The microprocessor may, in complex configurations, be programmed and set for a plurality of handpieces and treatments according to operating needs.

One of the needs which current apparatus of this kind is unable to satisfy, however, is that of monitoring the actual “work” done by the handpieces during use (for example, by handpiece burs for implant applications or by dental filing tools for endodontic operations) allowing the dental surgeon to view the physiological and structural parameters of the parts concerned immediately: indicating, for example, how compact a tooth being treated is, whether the tool on the handpiece is working on soft tissue, etc.

These parameters are very important because they enable the dental surgeon to make an immediate decision as to the therapy to apply next or the implant to use on the patient.

At present, data regarding operating torque actually applied to a handpiece can be recorded on this stand-alone apparatus to which the handpieces used for these treatments can be connected.

In this case, the stand-alone apparatus has a unit that records the torque used during treatment and saves the information to a smart card. The information recorded can then be transferred to another unit or PC capable of displaying or printing it.

The information obtained in this way, however, is used for statistical purposes only, since the treatment and subsequent therapies have already been applied on the basis of what the surgeon saw at the time of the treatment and his/her own experience.

The present invention therefore has for an aim to overcome the above mentioned drawbacks by providing an auxiliary apparatus for dental treatments which offers the possibility of displaying the torque applied to the handpieces during operation.

### SUMMARY OF THE INVENTION

In accordance with the invention, this aim is achieved by an auxiliary apparatus for dental treatments comprising: a main body constituting a power unit that drives handpieces used for traditional conservative, implant and/or endodontic operations and in turn connected to the unit through a connecting tube; handpiece activation and adjustment means located on a surface of the main body and controlled by a microprocessor unit for controlling the main and auxiliary functions of the handpiece applied to the unit; a data display screen mounted on the main body; an interface unit connected, on one side, to the microprocessor and, on the other, to the screen and designed to receive from the microprocessor at least one signal corresponding to a data item that is a function of the torque value of the handpiece being used and to convert it into at least one graphic viewing field on the screen in real time so as to display the graph of torque over time corresponding to the use of the connected handpiece.

### BRIEF DESCRIPTION OF THE DRAWINGS

The technical characteristics of the invention, with reference to the above aims, are clearly described in the claims below and its advantages are apparent from the detailed description which follows, with reference to the accompanying drawings which illustrate a preferred embodiment of the invention provided merely by way of example without restricting the scope of the inventive concept, and in which:

FIG. 1 shows an auxiliary apparatus for dental treatments according to the present invention in a schematic perspective view with some parts cut away to better illustrate others;

FIG. 2 is a diagram illustrating some of the parts of the apparatus of FIG. 1.

### DESCRIPTION OF THE PREFERRED EMBODIMENTS

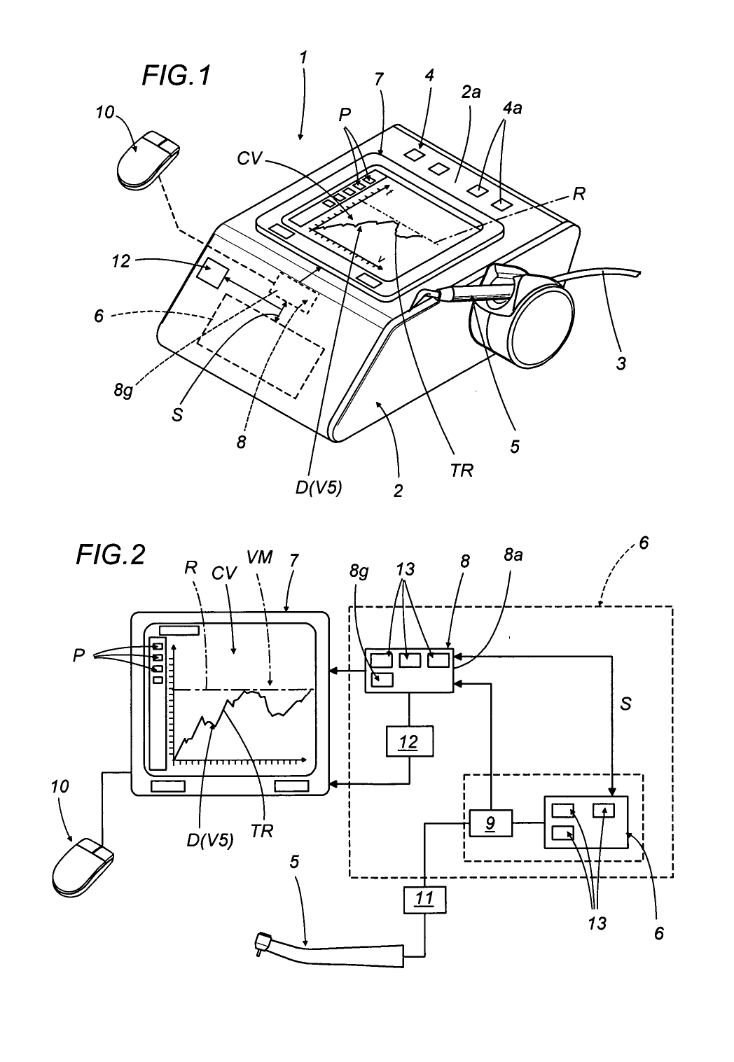

With reference to the accompanying drawings, in particular FIG. 1, the auxiliary apparatus for dental treatments according to the invention is labeled 1 in its entirety and comprises, insofar as is relevant to the present invention:

a main body 2 (for example, shaped substantially like a parallelepiped, but without thereby restricting the scope of the invention) constituting a power unit that drives handpieces 5 used for traditional conservative, implant and/or endodontic operations and in turn connected to the unit 2 through a connecting tube 3 (equipped with an appropriate end fitting);

means 4 for activating the handpiece 5 and adjusting the operating parameters of the handpiece 5, said means (for example pushbuttons 4a) being located on a surface 2a of the main body 2 and being controlled by a microprocessor unit 6 (illustrated as a block in the drawings) for controlling the main and auxiliary functions of the handpiece 5 applied to the unit 2.

Depending on the type of treatment, the handpieces applicable to the apparatus may be of several different kinds, such as, for example, handpiece burs for implant surgery or dental filing tools for endodontic surgery.

Obviously, the apparatus according to the invention may include additional auxiliary components (for example, a bag of physiological saline connected directly to the handpiece and providing a separate fluid supply during treatment) without thereby restricting the scope of the invention.

As shown in FIG. 1, the apparatus 1 also comprises:

a data display screen 7 mounted on the main body 2;

an interface unit 8 connected, on one side, to the microprocessor 6 and, on the other, to the screen 7 and designed to receive from the microprocessor 6 at least one signal S corresponding to a data item D that is a function of the torque value V5 of the active handpieces 5 and to convert it into at least one graphic viewing field CV on the screen 7 in real time so as display the graph TR of torque over time t corresponding to the use of the selected handpiece 5.

In other words, an apparatus 1 structured in this way can display the torque applied to the active handpiece 5 in real time, that is to say, while the patient is being treated.

The screen 7 preferably, but not necessarily, forms an integral part of the main body 2 and may be built into the surface 2a of the main body 2 itself.

As shown also in FIG. 2, the interface unit 8 may be a separate secondary microprocessor unit 8a.

Alternatively, the interface unit 8 may comprise a real-time graphic processing unit 8g.

According to another alternative, the interface unit 8 may be built into the primary microprocessor unit 6.

FIG. 2 also shows how the interface unit 8 makes it possible to produce a Cartesian graph showing, on the y-axis, the values V of the aforementioned torque and, on the x-axis, the values of the time t within which the real-time graph TR of the torque value V5 is displayed.

In addition to the above, the viewing field may also, advantageously, present other data related to the torque value displayed in real time.

Thus the microprocessor 6 may support a unit 9 for controlling at least the torque value V5 of the handpiece 5 used. These values are variables forming part of parameters P that depend on the type of application, that is, traditional conservative operations, implants or endodontic operations.

The settings defined by the parameters P of the handpiece 5 working values V5 may be displayed beside the graph in the graphic viewing field CV on the screen 7 according to the applied handpiece 5, for example, in the form of different icons in different colors depending on the type of treatment.

If the interface unit 8 consists of a secondary microprocessor, the parameters P of the operating values may be stored in the secondary microprocessor itself and may be selected directly from the graphic viewing field CV using a first peripheral unit 10 (for example, a mouse) connected to the interface unit 8 and designed to communicate both ways with the primary microprocessor 6 in order to make the appropriate selections relating to the handpiece 5.

Similarly, the above mentioned control unit 9 may be equipped with means 11 for limiting the maximum value VM assignable to the torque value V according to the type of operation and type of handpiece 5 used.

The maximum value VM of the torque value V assignable to the selected handpiece 5 may be displayed in the graphic viewing field CV in the form of a straight line R parallel to the x-axis of the graph.

The two-way connection between the interface unit 8 and the primary microprocessor 6 makes it possible to generate the graph TR in the graphic viewing field CV in real time when the handpiece 5 to be used is switched on and, if necessary, keeps the graph TR on screen when the handpiece 5 is switched off so that the graph TR may be continued from the same point when the handpiece 5 is switched on again, thus obtaining an uninterrupted graph TR on the screen 7 throughout the treatment required.

For completing the structure, the interface unit 8 might be connected to a second peripheral unit 12 for issuing an audible signal, activated by the interface unit 8 itself when the torque value V of the handpiece 5 being used approaches the maximum value VM assigned. The peripheral unit 12 may be set to increase or decrease the intensity of the audible signal depending on how close the torque value V5 recorded at that moment is to the maximum value VM set.

In this way, the surgeon can be alerted immediately to the maximum torque applied to the handpiece being used.

For improved performance of the apparatus 1, the interface unit 8 and the microprocessor 6 might be equipped with memory banks 13 enabling the graphs TR plotted on the screen 7 in real time to be stored and thereby permitting the creation of an archive of specific patient treatments.

This storage facility would also enable two or more stored graphs TR to be displayed simultaneously by the interface unit 8 and superimposed in the viewing field CV on the screen 7 so as to compare different types of treatment or different types of tissue.

An apparatus made in this way thus achieves the aforementioned aims thanks to the possibility of administering dental treatments with handpieces of different types whose operation is constantly monitored at least as regards the torque applied to them during operation.

On-screen displaying of torque/time graphs on line gives the surgeon an immediate view of the torque applied to the tool during work.

This information, for example regarding a bur (during implant treatments) or a dental filing tool (during endodontic treatments) is important and useful because it provides an immediate indication of the tooth or bone structure of the part being treated and enables the surgeon to quickly decide how to proceed with the treatment, what diameter or length of tools to use, etc.

All of this is achieved in a full-featured structure allowing extremely rapid display and selection times, with obvious advantages for both the surgeon and the patient.

It will be understood that the invention described may be useful in many industrial applications and may be modified and adapted in several ways without thereby departing from the scope of the inventive concept. Moreover, all the details of the invention may be substituted by technically equivalent elements.

1. An auxiliary apparatus for dental treatments, the apparatus (1) being of the type comprising at least:
a main body (2) constituting a power unit that drives handpieces (5) used for traditional conservative, implant and/or endodontic operations and in turn connected to the unit (2) through a connecting tube (3);
handpiece (5) activation and adjustment means (4) located on a surface (2a) of the main body (2) and being controlled by
a microprocessor unit (6) for controlling the main and auxiliary functions of the handpiece (5) applied to the unit (2);
the apparatus (1) further comprising:
a data display screen (7) mounted on the main body (2);
an interface unit (8) connected, on one side, to the microprocessor (6) and, on the other, to the screen (7) and designed to receive from the microprocessor (6) at least one signal (S) corresponding to a data item (D) that is a function of the torque value (V5) of the handpiece (5) being used and to convert this signal into at least one graphic viewing field (CV) on the screen (7) in real time so as to display the graph (TR) of torque over time (t) corresponding to the use of the handpiece (5).

2. The apparatus according to claim 1, wherein the interface unit (8) comprises a separate, secondary microprocessor unit (8a).

3. The apparatus according to claim 1, wherein the interface unit (8) comprises a real-time graphic processing unit (8g).

4. The apparatus according to claim 1, wherein the interface unit (8) forms an integral part of the primary microprocessor unit (6).

5. The apparatus according to claim 1, wherein the interface unit (8) produces a Cartesian graph showing, on the y-axis, the values (V) of torque and, on the x-axis, the values of the time (t) within which the real-time graph (TR) of the torque value (V5) is displayed.

6. The apparatus according to claim 1, where the microprocessor (6) supports a unit (9) for controlling at least the torque value (V5) of the usable handpieces (5), being variables forming part of parameters (P) that depend on the type of application, that is, traditional conservative operations, implants or endodontic operations, the apparatus being wherein the parameters (P) of the operating values (V5) of the handpiece (5) are displayed in the graphic viewing field (CV) on the screen (7) in accordance with the handpiece (5) used.

7. The apparatus according to claim 6, wherein the interface unit (8) comprises a secondary microprocessor and the parameters (P) of the operating values can be stored in said secondary microprocessor and can be selected directly from the graphic viewing field (CV) through a peripheral unit (10) connected to the interface unit (8) itself.

8. The apparatus according to claim 6, where the control unit (9) is equipped with means (11) for limiting the maximum value (VM) assignable to the torque value (V) according to the type of operation and type of handpiece (5), the apparatus being wherein the maximum value (VM) of the value (V) assignable to the handpiece (5) is displayed in the graphic viewing field (CV) in the form of a straight line (R) parallel to the x-axis of the graph.

9. The apparatus according to claim 8, wherein the interface unit (8) comprises a peripheral unit (12) for issuing an audible signal, activated by the interface unit (8) itself when the torque value (V) approaches the maximum value (VM) assigned.

10. The apparatus according to claim 1, wherein the interface unit (8) and the microprocessor (6) are equipped with memory banks (13) for storing the graphs (TR) plotted on the screen (7) in real time.

11. The apparatus according to claim 10, wherein the interface unit (8) enables two or more stored graphs (TR) to be displayed simultaneously and superimposed in the viewing field (CV) on the screen (7).

12. The apparatus according to claim 1, wherein the interface unit (8) is connected to and communicates with the microprocessor (6) in such a way as to generate the graph (TR) in the graphic viewing field (CV) in real time when the handpiece (5) to be used is switched on and to keep the graph (TR) on screen when the handpiece (5) is switched off so that the graph (TR) may be continued from the same point when the handpiece (5) is switched on again, thus obtaining an uninterrupted graph (TR) on the screen (7).

13. The apparatus according to claim 1, wherein the screen (7) forms an integral part of the main body (2) and is built into the surface (2a) of the main body (2) itself.
